(19) United States
(12) Patent Application Publication
(10) Pub. No.: US 2022/0161920 A1
(43) Pub. Date: May 26, 2022

(54) FREE STREAMLINE AIRFOIL

(71) Applicant: Brown University, Providence, RI (US)

(72) Inventors: Matteo DI LUCA, Arlington, MA (US); Kenneth BREUER, Newton, MA (US)

(21) Appl. No.: 17/534,802

(22) Filed: Nov. 24, 2021

Related U.S. Application Data
(60) Provisional application No. 63/118,266, filed on Nov. 25, 2020.

(51) Int. Cl. B64C 3/14; B64C 23/06

(52) U.S. Cl. CPC B64C 3/14; B64C 2003/149; B64C 23/06

(57) ABSTRACT

A free-streamline airfoil includes a lower surface which is flat or contoured, and an upper surface that is curved or made of discrete flat elements approximating a curved surface, the upper surface presenting a cavity, a cavity width in an airfoil chordwise direction shorter than the airfoil chord, a position and depth of the cavity triggering a turbulent flow over the airfoil's suction side while preserving the airfoil physical integrity.

### CROSS REFERENCE TO RELATED APPLICATIONS

This application claims benefit from U.S. Provisional Patent Application Ser. No. 63/118,266, filed Nov. 25, 2020, which is incorporated by reference in its entirety.

### STATEMENT REGARDING GOVERNMENT INTEREST

This invention was made with government support under grant number CMMI-1426338 awarded by the National Science Foundation. The government has certain rights in the invention.

### BACKGROUND OF THE INVENTION

The present invention relates generally to aerodynamics systems and apparatus for the production of lift or control forces for aircraft or missiles, and more particularly, to a free streamline airfoil.

In aerodynamics, the Reynolds number is a measure of the ratio of the inertial force of a gas to the viscous force, and is a dimensionless number. When the Reynolds number is smaller, the influence of the viscous force on the flow field is larger than the inertia force, the disturbance of the flow velocity in the flow field is attenuated due to the viscous force, and the fluid flows stably and is laminar. On the contrary, if the Reynolds number is larger, the influence of the inertia force on the flow field is larger than the viscous force, the fluid flow is unstable, the small change of the flow velocity is easy to develop and strengthen, and a turbulent and irregular turbulent flow field is formed.

When a chord based Reynolds number of an airfoil decreases, the airfoil power factor is greatly limited by a reduction in the maximum lift and the occurrence of large flow separation from the airfoil that increases drag. Turbulent flow on the airfoil suction side can improve the airfoil power factor, especially for high camber airfoils. The behavior is associated with the laminar to turbulent transition process and characteristic of the low Reynolds numbers regime and largely independent of airfoil shape.

The poor aerodynamic power factor of low Reynolds numbers airfoils greatly limits the flight time of small-scale drones. Although the power factor can be improved by maintaining a turbulent boundary layer over the wing, it is challenging to achieve at Reynolds numbers below 50,000.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In general, in one aspect, the invention features a free-streamline airfoil including a lower surface which is flat or contoured, and an upper surface that is curved or made of discrete flat elements approximating a curved surface, the upper surface presenting a cavity, a cavity width in an airfoil chordwise direction shorter than the airfoil chord, a position and depth of the cavity triggering a turbulent flow over the airfoil's suction side while preserving the airfoil physical integrity.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 illustrates an exemplary airfoil.

FIG. 2 illustrates an exemplary airfoil with an embedded cavity.

FIGS. 3A, 3B and 3C illustrate exemplary graphs.

FIGS. 4A and 4B illustrate exemplary graphs.

FIG. 5 is a flow diagram.

FIGS. 6A and 6B illustrate exemplary graphs.

FIG. 7 illustrates an AG14HC airfoil with a cavity designed for operations at Re_{c}=30,000.

FIGS. 8A and 8B illustrate exemplary graphs.

FIGS. 9A, 9B and 9C illustrate exemplary graphs.

FIGS. 10A and 10B illustrate exemplary graphs.

FIGS. 11A and 11B illustrate exemplary graphs.

FIGS. 12A and 12B illustrate exemplary graphs.

FIG. 13A illustrates an exemplary shape factor.

FIG. 13B illustrates an exemplary graph.

FIGS. 14A, 14B and 14C illustrate exemplary graphs.

FIGS. 15A, 15B and 15C illustrate exemplary graphs.

FIGS. 16A, 16B and 16C illustrate exemplary graphs.

FIGS. 17A and 17B illustrate exemplary graphs.

FIG. 18 illustrates an exemplary sketch with the variables of the laminar reattachment problem.

FIGS. 19A and 19B illustrate exemplary graphs.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

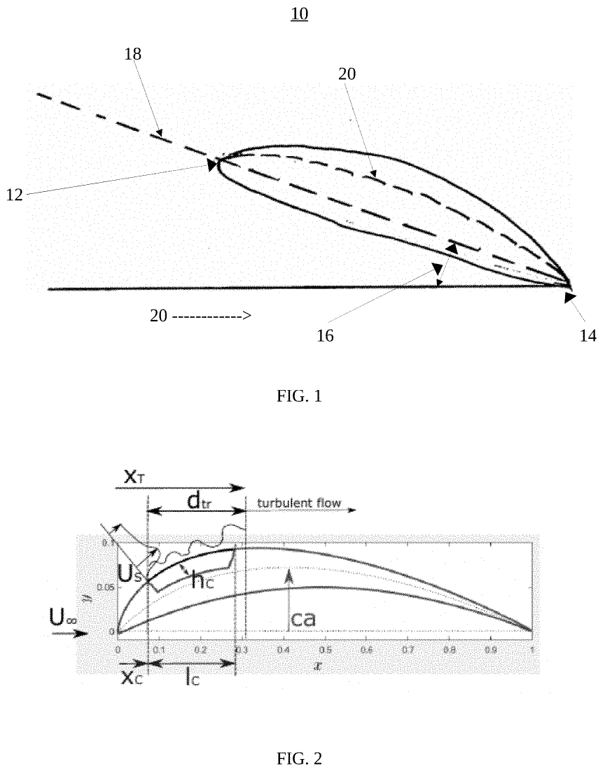

In general, lift and weight are two of the four forces acting on a drone or airplane, the other two being drag and thrust. A drone or airplane generates lift using its wings. A cross-sectional shape of a wing is typically referred as an airfoil. As shown in FIG. 1, an exemplary airfoil 10 includes a leading edge 12, a trailing edge 14, an angle of attack 16, a chord 18, a camber line 20 and an air flow 22. The chord 18 extends from the leading edge 12 to the trailing edge 14 of the wing. The camber line 20 points halfway between chord 18 and an upper wing surface. The angle of attack 16 is an angle between direction of the airflow 22 and the chord 18. Viscosity is essential in generating lift. The effects of viscosity lead to a formation of a starting vortex which, in turn is responsible for producing the proper conditions for lift.

The present invention combines high airfoil camber and a cavity carved into the suction side of the airfoil to generate a turbulent, attached flow. For example, the camber of a low Reynolds number AG14 airfoil is increased from 2% to 7% while the cavity position, length and depth are derived based on spatial linear stability theory of the separated shear layer over the cavity. Lift and power factors of the modified airfoils are characterized computationally using XFOIL, an interactive program released under the GNU General Public License for the design and analysis of subsonic isolated airfoils. The higher camber cavity airfoils show a 100% gain in power factor over a smooth AG14 at Reynolds 30,000 and 10,000. Wind tunnel testing of wings with the cavity airfoils showed power factor improvements of 30% and 80% at Reynolds 30,000 and 10,000 and hot wire measurements confirmed that the cavity triggers a turbulent boundary layer.

The flight time of a fixed wing vehicle is directly proportional to the wing power factor—the ratio between the airfoil lift coefficient to the power 1.5 and the drag coefficient, C_{L}^{1.5}/C_{D}. When the chord based Reynolds number, defined as Re_{c}=cU_{∞}/ν with, c, airfoil chord, U_{∞}, flight speed and, ν, air kinematic viscosity, decreases, the airfoil power factor is greatly limited by a reduction in the maximum lift and the onset of large flow separation from the airfoil that increases drag. Turbulent flow on the airfoil suction side can improve the airfoil power factor, especially for high camber airfoils.

Triggering a turbulent boundary layer at Re_{c}<50,000, however, is challenging. At low freestream turbulence, an attached boundary layer cannot transition over a distance shorter than the airfoil chord. Since disturbance amplification is far greater inside separated shear layers than in attached boundary layers, early flow separation allows a shorter transition distance and a boundary layer that is less sensitive to atmospheric turbulence. The performance robustness against atmospheric turbulence resulting from early flow separation is also observed in natural flyers. If, however, separation does not occur early, transition usually requires a large chord fraction. Moreover, as the Reynolds number decreases below Re_{c}<50,000, surface mounted or leading edge devices promoting flow separation, such as leading edge bumps, wires and flaps, become increasingly ineffective to trip the boundary layer.

Since modest surface treatments may not ensure transition to turbulence at these low Reynolds numbers, one way to achieve flow transition is to force flow separation using a sharp backward-facing step. Although such a sharp geometric discontinuity into a streamlined shape seems heretical to traditional aerodynamic design, this manuscript presents a design strategy to increase the power factor of airfoils and wings by combining high airfoil camber with a cavity carved into the airfoil surface. This design triggers early flow separation, promoting a rapid boundary layer transition which avoids large-scale flow separation in the pressure recovery region. Lift is significantly increased and often drag is also reduced for a favorable net effect.

To demonstrate, we first use numerical simulations to outline the benefits of turbulent flow and high camber to improve the power factor of an AG14 airfoil at Re_{c}=30,000. Based on these results, a suitable airfoil camber and a desired transition location are defined.

The present invention designs a cavity that can trigger a turbulent flow over the airfoil's suction side. As shown in FIG. 2 The cavity is defined by its leading edge position, x_{C}, its length, l_{C}, and depth, h_{C}. The cavity position and depth are chosen to trigger flow transition at a desirable location while preserving the airfoil physical integrity. Finally, the flow over the airfoil with a cavity carved into its surface is simulated to establish the cavity effectiveness in triggering a turbulent flow and to quantify the resulting lift and power factor improvements over the original airfoil.

The present invention can be extended to an airfoil operating at an even lower Reynolds number—Re_{C}=10 000—and illustrates the challenges associated with the separated shear layer becoming prone to laminar reattachment at such low Reynolds numbers.

To validate these numerical design concepts we present experimental results at both Re_{C}=10,000 and 30,000. These measurements include lift and drag measurements, as well as hot wire anemometry to assess the state of the boundary layer over the upper surface of the wing. At Reynolds numbers Re_{c}<10,000, separated flows may not transition due to the shear layer tendency for laminar reattachment.

As discussed above, airfoil lift and power factor have been characterized using XFOIL—a computational tool widely used in airfoil design—which provides the excellent design flexibility and good accuracy required to simulate transitional low Reynolds number flows. The initial airfoil for the design method is the AG14, a low Reynolds number airfoil designed for hand-launched gliders. To study the effects of airfoil camber on aerodynamic performance, the XFOIL geometry design routine was used to generate a series of airfoils with camber between 2% and 9%. Laminar to turbulent transition in XFOIL is modeled based on solutions of the Orr-Sommerfeld equation for the Falkner-Skan velocity profile family and the e N method. Transition is achieved when disturbances inside the shear layer have been amplified e Ncrit times. The value of the critical amplification factor, N cr it, depends upon the freestream turbulence level and was chosen to be 9.

Characterization of airfoils both with and without a cavity relied on XFOIL simulations. XFOIL simulations of the flow around the cavity airfoil started with the airfoil geometry including the cavity as an input. However, the XFOIL design environment is not intended to be used with sharp geometries such as the cavity airfoils, and we experienced difficulties in achieving converged simulations during the exploration of the design space. For this reason, the cavity design process was based on a custom transition model developed independently. This model allowed us to quantify the transition distance, transition location, and the required cavity depth dependency on a prescribed separation location. The growth rates of disturbances inside the separated shear layer were computed using spatial viscous linear stability theory. The Orr-Sommerfeld equation was solved numerically using a Chebyshev collocation method with a linear companion matrix method to determine the eigenvalues.

To improve the convergence of XFOIL simulations used for the characterization of the cavity airfoils, the cavity leading and trailing edge surfaces were not normal to the adjacent airfoil surface. When converged solutions were achieved, they were independent of the parameter set (i.e., the solution was unique).

Aerodynamic forces on full wing systems were modeled combining the 2D XFOIL airfoil performance predictions with AVL (Athena Vortex Lattice) to account for 3D effects. For a given angle of attack, the vortex lattice method determines the wing sectional lift distribution starting from the distribution of the sectional airfoil c₁-α slopes. The c₁-α slope for each section can be either prescribed or is computed by AVL from the local airfoil camber line using thin airfoil theory. With the wing sectional lift and induced drag coefficients established from AVL, wing sectional profile drag coefficients were derived from the airfoil aerodynamic polar curves obtained using XFOIL. The model stops at the angle of attack of wing stall, when a section of the wing has stalled, c₁>c_{1, max}, with the value of the airfoil maximum lift coefficient, c 1 max, obtained from the XFOIL airfoil simulation.

Experimentally, the wings used in wind tunnel testing were 3D-printed (FormLabs2) with a 45 cm wingspan and a 8.5 cm chord length (aspect ratio of 5.3). For lift and drag measurements, the wings were installed on a six-axis force sensor (Nano17, ATI) at the center of the Brown University low-turbulence 1.2 m×1.2 m low-speed wind tunnel test section. The wings were mounted inside the tunnel on a model positioning system with angular resolution of 0.1 degrees in both pitch and yaw. The wind tunnel velocity was measured using a Pitot tube and a high-precision pressure transducer (MKS Baratron 120 AD). The resulting accuracy in velocity is ±0.06% at U_{∞}=1.75 m/s (Re_{c}=10,000). The resolution of the force transducer is 1/320 N in Fx, Fy, Fz, leading to a CL and CD resolution of 0.005 at Re=30,000 and 0.014 at Re=10,000. To minimize any temperature fluctuations, the transducer tare was acquired with the wind on and the model shielded by a cardboard box. All force measurements were repeated three times and between each measurement, the wind tunnel was turned off and the model re-assembled on the support.

The baseline freestream turbulence levels in the test section were quantified using the standard deviation of the streamwise velocity component normalized by the mean velocity. Velocities were measured at the position of the wing center-span using a single probe hot wire anemometer and determined to be 0.02%±0.01% at 2 m/s (f>4 Hz) and 0.02%±0.005% at 8 m/s (f>4 Hz).

The cavity effectiveness in triggering boundary layer transition to turbulence over the airfoil was also assessed. The boundary layer state at the cavity trailing edge was measured using a hot-wire anemometer mounted on a 2 degree-of-freedom traverse system with resolution of 12.7 μm/step. The hot wire (5 μm diameter) was calibrated in the wind tunnel over a speed range 0-8 m/s against the Pitot tube and high-precision pressure transducer (MKS Baratron 120AD).

Although we are concerned with both airfoil and wing performance, the conditions that minimize their respective aerodynamic power are not the same. If it is assumed that the wing lift and drag coefficients, C_{L} and C_{D}, approximate that of a fixed wing vehicle, the wing power factor, C_{L}^{3/2}/C_{D}, is directly proportional to the vehicle flight time.

Considering the airfoil lift and drag coefficients, c_{L} and c_{D}, it is reasonable to assume that the wing operates at a lift coefficient comparable to the airfoil lift coefficient, C_{L}≈c_{L}. Accounting for the induced drag term, we can write

$${C}_{D} \approx {c}_{d} + \frac{\text{?}}{π AR} , \\ \text{?} \text{indicates text missing or illegible when filed} \qquad ( 1 )$$

which includes the dependency on the wing aspect ratio, AR. The wing aerodynamic power is minimized when

$$\frac{{C}_{D}}{{C}_{L}^{3 / 2}} = \frac{{c}_{d}}{\text{?}} + \frac{\text{?}}{π AR} \\ \text{?} \text{indicates text missing or illegible when filed} \qquad ( 2 )$$

is minimized.

Therefore, minimizing c_{D}/c_{L}^{3/2} is different from minimizing C_{D}/C_{L}^{3/2}, although the higher the aspect ratio, the smaller the difference between the two expressions. The objective of the present study is to illustrate the cavity design process, and despite the difference between the airfoil power factor and the wing power factor, the aspect ratio term is ignored in the airfoil selection process to simplify the treatment. As a result, the cavity design starts with airfoil camber selection (and transition location) that minimize c_{D}/c_{L}^{3/2}.

Turbulent flow, high camber and transition location benefits on airfoil power factor at Re_{c}=30,000.

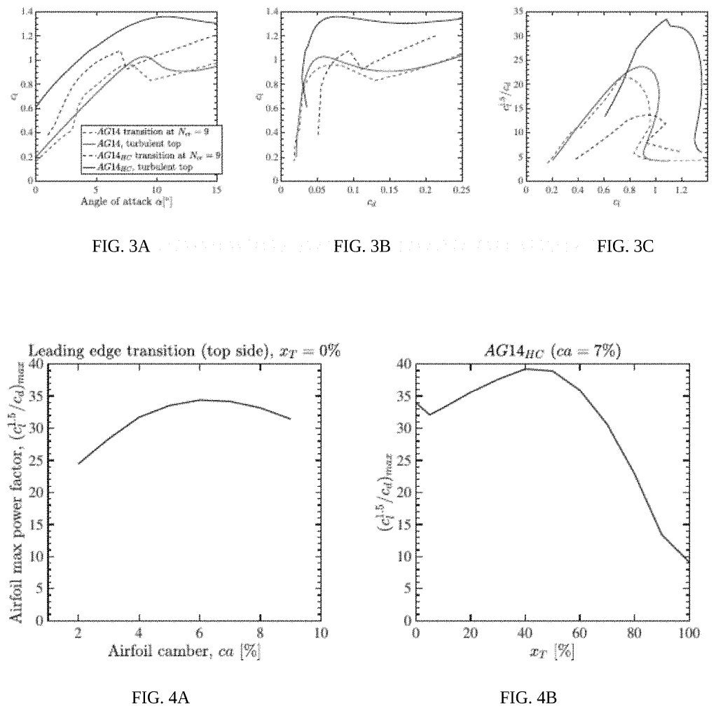

The effects of (i) establishing a turbulent boundary layer over the airfoil suction side and (ii) airfoil camber are illustrated by means of a computational example at Re_{c}=30,000. The performance of the baseline AG14 airfoil, a fairly thin (5%) and low cambered (2%) airfoil used for low Re numbers applications, is compared to the performance of a modified version with 7% camber, named here AG14HC. When a turbulent boundary layer over the airfoil is not enforced, increasing the airfoil camber brings an increase in c_{L} (FIG. 3A). The lift increase comes at the expense of extensive flow separation which increases drag (FIG. 3B) and halves the airfoil power factor (FIG. 3C). Conversely, simulations which force a turbulent boundary layer over the airfoil suction side, show greatly enhanced lift and a power factor improvement up to 50% for the AG14HC airfoil compared with the AG14 (FIGS. 3A,3C). Both lift and power factor improvements are due to the turbulent boundary layer's ability to withstand higher adverse pressure gradients as compared to that of a laminar boundary layer, and this example emphasizes the need to trigger the transition in order to achieve good aerodynamic performance.

Before a discussion of the cavity design, we first select the airfoil camber, ca (represented in FIG. 2), that maximizes the power factor. The AG14 airfoil was modified with camber ranging from 2% to 9% and turbulent flow was forced on the upper surface at the airfoil leading edge. A camber between 6% and 8% maximizes the airfoil power factor (FIG. 4A) and for this reason, an airfoil with 7% camber, AG14HC, was chosen as the starting airfoil for the cavity design.

The transition location, xT (depicted schematically in FIG. 2), is expected to influence airfoil performance given its impact on both friction and pressure drag. Where should transition be located, and how sensitive is the airfoil power factor to that location? To answer both questions, the flow over the AG14HC airfoil was simulated, forcing the transition location on the top side at different locations between the leading and trailing edge, x_{T}=[0%-100%]. For each transition location, the flow over the airfoil was simulated over a range of angles of attack, α=1°-15°, to determine the maximum aerodynamic power factor, (C_{L}^{1.5}/C_{D})ₘₐₓ. As shown in FIG. 4B, a turbulent boundary layer improves the maximum power factor by as over 100% with respect to the laminar boundary layer case (x_{T}=100%). As already seen (FIG. 3C), transition at the leading edge results in a high power factor condition, however, an additional 20% can be gained by moving the transition rearward, to x_{T}=40% (FIG. 4A). As the power factor rapidly degrades for x_{T}>60%, it is desirable to complete transition to turbulence before the mid-chord.

Cavity Design at Re_{c}=30,000.

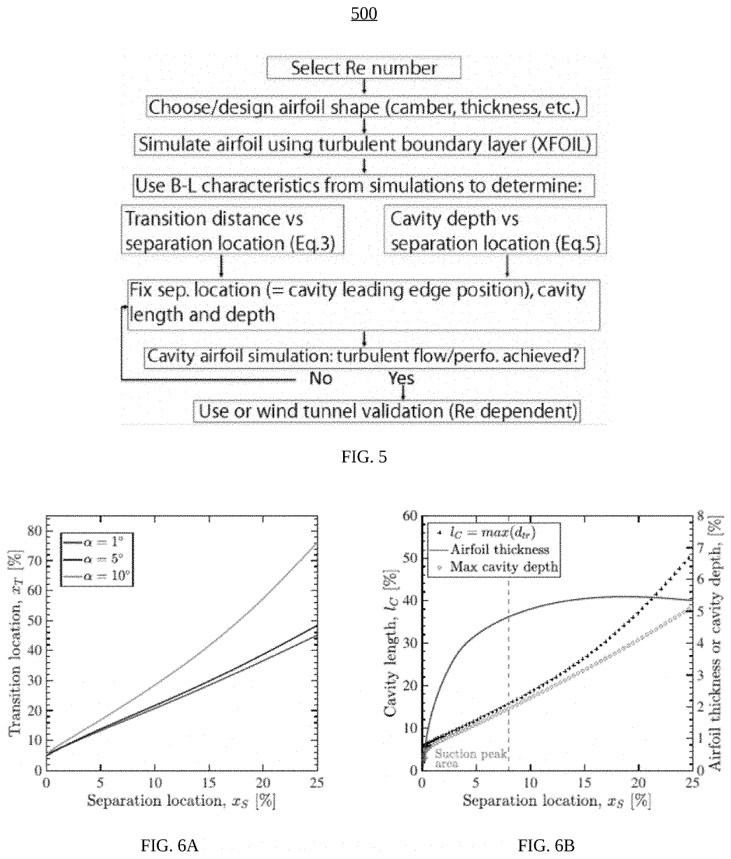

In FIG. 5, a process 500 to define the cavity starting position, x_{C}, its length, l_{C}, and depth, h_{C}, (all normalized by the airfoil chord, c) is illustrated here through a specific example at Re_{c}=30,000.

1) depending on the Reynolds number of interest, an airfoil shape (e.g., maximum camber, thickness, camber line, etc.) is chosen. Starting from a low Reynolds number airfoil, a simplified method to obtain a suitable airfoil shape (i.e., with increased camber) is used herein.

2) XFOIL simulations of the flow around the chosen airfoil are used to establish the baseline boundary layer characteristics (e.g., momentum thickness, edge velocity, etc.). For this step, a turbulent boundary layer over the entire suction side is assumed.

3) from this, the relationship between the separation location and the boundary layer transition location is derived.

4) the relationship between the separation location and the required cavity depth is derived.

5) based on these results, a suitable location to fix flow separation is chosen. This location defines the cavity leading edge position. Furthermore, fixing the cavity leading edge allows us to establish the cavity depth and length.

6) the flow around the airfoil with the cavity carved into its surface is simulated using XFOIL to verify whether transition is achieved at the desired location and whether the airfoil has the desired level of performance. If not, the cavity position, depth and length are re-calculated.

7) wind tunnel tests are performed to validate model as needed.

The first step is to determine the transition location, x_{T}=x_{S}+dₜᵣ, that would be obtained if the boundary layer separated from the airfoil surface at the location x_{S} (after the separation location has been chosen, x_{S}=x_{c} as in FIG. 2). With this knowledge, separation can be forced at a location that triggers transition at the desired location. However, to ensure structural integrity of the airfoil, the cavity needs to be much shallower than the local airfoil thickness. At the Reynolds numbers of interest, the ideal cavity depth can be a major fraction of the airfoil thickness. Therefore, the second step is to derive the cavity depth requirement, based on the location of flow separation, x_{S}. Once the separation location is established, it coincides with the cavity leading edge position (i.e. x_{S}=x_{c} in FIG. 2).

With a cavity leading edge position and depth defined, the transition location, x_{T}, is predicted using linear stability theory for parallel flows, and the e^{N} method:

$${N}_{crit} = log \text{?} = \text{?} - \text{?} dx , \\ \text{?} \text{indicates text missing or illegible when filed} \qquad ( 3 )$$

where vₓₛ and v_{xT} are the amplitudes of the normal velocity perturbations at separation and transition, θ (x) is the momentum thickness distribution along the airfoil chord (normalized by the airfoil chord, c), α is the dimensionless spatial growth rate of disturbances, and N_{crit} it is the amplification factor required for flow disturbances to generate a turbulent flow. N_{crit} it depends on the freestream turbulence level (i.e. the initial amplitude of the disturbance at separation v_{xS}).

For a given angle of attack, the transition location, x_{T}, is determined solving Eq. 3. An XFOIL simulation of the flow over the AG14HC airfoil without the cavity and forcing a turbulent flow at the airfoil leading edge provides the distributions of the momentum thickness, θ (x), and the local Reynolds number, Re θ (x)=θ (x) Uₑ (x)/v, where Uₑ (x) is the boundary layer edge velocity. In solving, Eq. 3, the growth rates, α, are found by solving the Orr-Sommerfeld equation for a series of velocity profiles parameterized by θ, Re_{θ} and H, where θ (normalized by the airfoil chord, c) and Re_{θ} are provided from the XFOIL simulation of the smooth airfoil at the appropriate angle of attack. H is held fixed at a value of 20 to account for the disturbance growth that would be experienced if a cavity was present. H=20 was used which has been previously found to maximize the disturbance growth inside a separated shear layer at the low Reynolds number studied here.

Solving Eq. 3 for α=1°, 5°, and 10°, yields the transition location, x_{T}, function of the separation location, x_{S} (FIG. 6A). The range of angle of attack is representative of the AG14HC operating range (FIG. 3A) and the maximum angle of 10° was arbitrarily chosen as close to the onset of stall. For all three angles of attack, the transition location moves considerably aft, as both dtr and x S increase moving away from the leading edge. The increase in dₜᵣ with x_{S} is due to the rapid increase of θ (x) (denominator in Eq. 3) and only a minor increase of α(Re_{θ}, H=20) (numerator in Eq. 3).

Since the objective of the cavity is to trigger flow transition at all the angles of attack of interest, the required cavity length, l_{c}, is set equal to the maximum of the transition distance, d_{TR}=x_{T}−x_{S}, over all three angles of attack (FIG. 6B).

The second step in the cavity design process is to determine the dependency of the cavity depth at separation, h_{C}, on the separation location, x_{S}. The boundary layer variables immediately before and after separation are indicated with the subscripts ₋ and ₊ respectively. The presence of the cavity with dimensional height, h, affects the displacement thickness at separation, δ₊^{★}=δ₋^{★}+h, but not the momentum thickness, θ₊=θ₋. This is because the displacement thickness, δ^{★}, and the momentum thickness, θ, for the separated flow are proxies of the distance from the wall to the shear layer centerline and for the shear layer thickness respectively. From the definition of the shape factors, H₊ and H₋, and using the previous assumption, it is possible to write

$${H}_{+} - {H}_{-} = \text{?} - \text{?} \approx \text{?} - \text{?} = \text{?} \\ \text{?} \text{indicates text missing or illegible when filed} \qquad ( 4 )$$

Introducing the definition of Re_{θ} and Re_{c} into Eq. 4 and using h_{S}=h/c, the normalized cavity depth at separation is given by

$${h}_{S} = ( {H}_{+} - {H}_{-} ) \text{?} \text{?} \text{?} \\ \text{?} \text{indicates text missing or illegible when filed} \qquad ( 5 )$$

The equation above details the dependency of the cavity depth at separation on the values at separation of the boundary layer variables Re_{θ} and Ue. In the design process, the values of the shape factors H₊ and H₋ in Eq. 5 are equal to 20 and 2.59 (zero-pressure gradient laminar boundary layer) respectively. Analogous to the procedure described above, H_{S} is obtained at a given angle of attack from the Re_{θ} and U_{∞}/U distributions derived from XFOIL simulations of the flow over the smooth airfoil (without the cavity). At each possible separation location, h_{S}, the required cavity depth, h, is the maximum of the depth, H_{S}, for the three different angles of attack (1°, 5°, and 10°, in FIG. 6B). The required cavity depth increases with the separation location mainly due to the Re_{θ} dependency (Eq. 5). The requirement to preserve the airfoil physical integrity limits the downstream location of separation since the required cavity depth and length both increase with the separation location, while the airfoil thickness decreases as one moves toward the trailing edge. For this reason, the cavity depth should be less than the airfoil local thickness (FIG. 6B). To satisfy this constraint in the current example, at Re_{c}=30,000, flow separation can occur at a distance no larger than 26% from the leading edge (FIG. 6B).

Moving toward the leading edge, triggering flow separation after the suction peak would preserve the airfoil capability to generate high speeds on its surface which is desirable for high lift and low drag. Between α=1° and 10°, the suction peak occurs before x=8%, and thus the optimal separation location is between 8% and 26%. We choose to place the separation location x_{S}=8% and thus the cavity is placed at x_{C}=8%. The corresponding cavity depth at separation is h_{C}=2%, and the cavity length is l_{C}=16% (both derived from FIG. 6B).

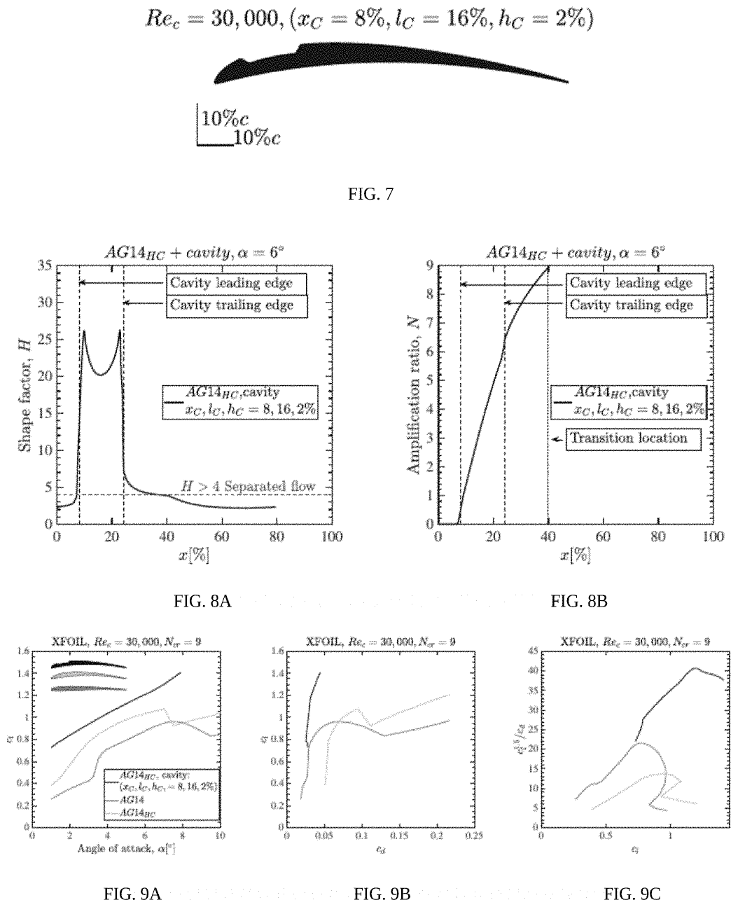

To evaluate this design, the flow over the resulting AG14HC airfoil with the cavity (FIG. 7) was simulated using XFOIL and the cavity effectiveness in triggering turbulence assessed through the distributions of the boundary layer shape factor, H, and the disturbance amplification rate, N. At the condition of airfoil maximum power factor, α=6°, the boundary layer shape factor over the cavity region x=8%-24% shows values between 18 and 25 (FIG. 8A). The large distance between the shear layer and the wall fosters rapid disturbance growth, as shown by the growing amplification rate, N (FIG. 8B). Although the transition process is incomplete at the cavity trailing edge (N<9), the shear layer is far enough from the wall that disturbances still grow, albeit at a reduced rate (FIG. 7b), and transition, N=9, occurs at 40% of the airfoil chord.

The major reason for the discrepancy between the transition distance predicted from Eq. 3 during the cavity design (FIG. 6A) and the XFOIL simulations to characterize the cavity airfoil (FIG. 8B) is due to the use of different distributions for θ (x). The transition distance computed from Eq. 3 to design the cavity uses the momentum thickness distribution around the smooth airfoil without a cavity. The introduction of a cavity, however, changes the momentum thickness distribution and is accounted for in the XFOIL simulations.

It was verified that the discrepancy between the transition distance predicted from Eq. 3 during design and the XFOIL performance evaluation simulations was not due to the use of a turbulent momentum thickness distribution for the n-factor analysis. An analysis with the momentum thickness distribution from a laminar boundary layer undergoing natural transition over the airfoil was also carried out. The additional set of transition location vs separation location curves (not shown for clarity) were very similar to the curves shown in FIG. 6A.

If the objective was to create a cavity that ensures flow transition at its trailing edge, additional design iterations would be required. However, as mentioned earlier, the current design tools have difficulties in achieving converged simulations for cavity airfoils, although with the benefits of these design established, we hope efforts will be made to address these challenges.

Downstream of the cavity, the turbulent boundary layer remains attached on the airfoil surface (H<4, FIG. 8A) resulting in a low drag condition. Since the cavity triggers flow transition within the airfoil mid-chord, the modified airfoil can generate lift coefficients up to 1.4, a 30% improvement over the AG14HC airfoil and a 45% improvement over the original AG14 airfoil (FIG. 9A, FIG. 9B). The cavity improves the airfoil maximum power factor by almost 100% compared to the original AG14 airfoil (FIG. 9C) and by 160% compared to the AG14HC airfoil. The improvement persists over a broad range of angles of attack.

Cavity Design at Re c=10,000

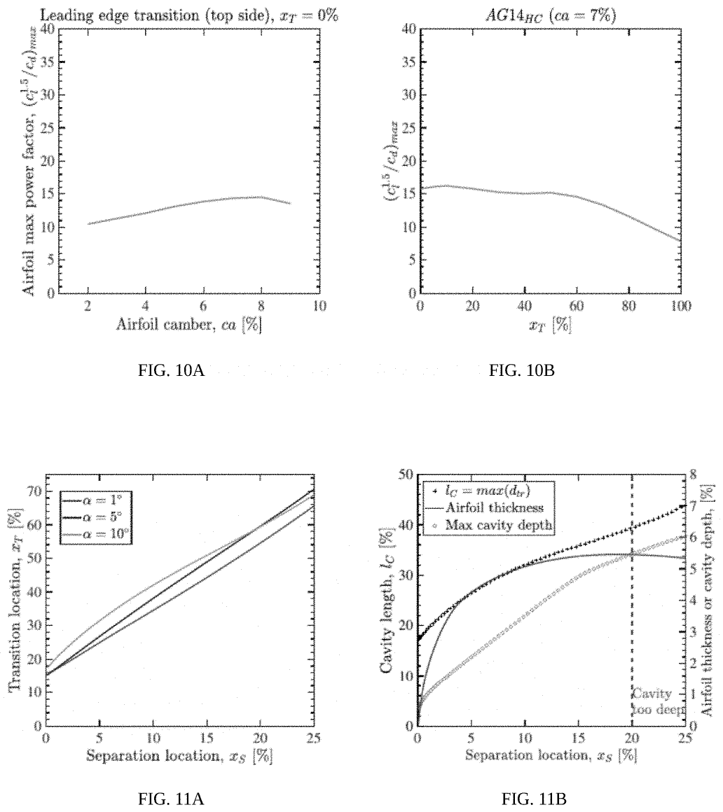

Here, we repeat the design process, this time at Re_{c}=10,000, to illustrate the challenges associated with the tendency of the separated shear layer to a laminar reattachment over the cavity surface at these very low Reynolds numbers. As with the Re_{c}=30,000 case, the AG14HC airfoil is the airfoil of choice, as a 7% camber maximizes the airfoil power factor (FIG. 10A). At Re c=10,000, differently from the Re_{c}=30,000 case, a leading edge transition maximizes the power factor. The power factor, however, is only mildly (<10%) sensitive to the transition location for x_{T}<60% while a dramatic drop occurs for x_{T}>60% (FIG. 10B). Therefore, it is desirable that the cavity promote flow transition very near the leading edge.

The transition location as a function of the separation location for three angles of attack is shown in FIG. 11A. Similar to the Re_{c}=30,000 case, the transition location moves considerably aft when the separation point moves away from the leading edge. Compared to the Re_{c}=30,000 case, however, the required cavity length almost doubles (FIG. 11B) and the cavity depth also increases, mainly due to the Re_{c} dependency in Eq. 5. Placing the cavity near the leading edge seems a natural design choice since transition near the leading edge maximizes the power factor. The closest leading edge location that still ensures sufficient airfoil solidity is x C=1% (FIG. 11B).

Simulating in XFOIL the flow over the airfoil with a cavity length of l_{c}=31% (initial length l_{c}=18%, from FIG. 11B) was effective in promoting flow transition at 42% of the airfoil chord (at the angle of maximum power factor, α=6°). In fact, even though the cavity length is still not enough to obtain transition at its trailing edge (FIG. 12B), disturbances continue to grow after the cavity trailing edge and during the reattachment process, assisted by a shape factor H≈6 (FIG. 12A). Transition to turbulence is obtained at x=42% and the turbulent boundary layer remains attached, i.e., H<4, over the remaining airfoil surface resulting in a high power factor.

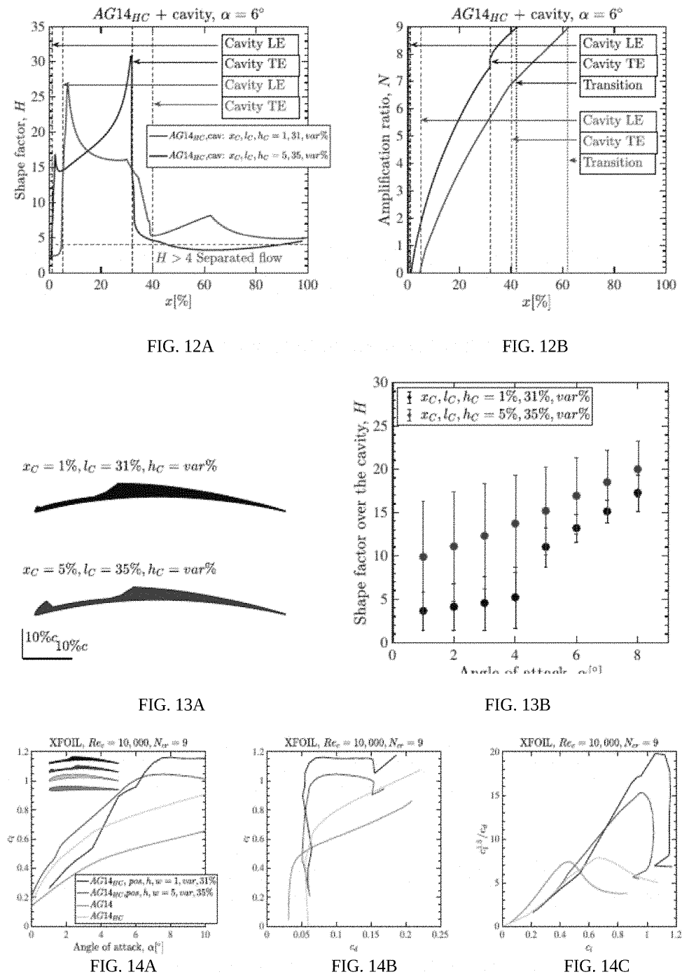

Although this design choice (FIG. 13A) provides high peak performance, the cavity suffers from laminar reattachment over the cavity surface at low angles of attack, α<5°. The flow reattaches over the surface soon after separation, resulting in low average shape factors at α<5° (FIG. 13B, average and standard deviation of the shape factor) and flow transition is inhibited. As a result, the low c 1 and power factor steeply increase with angle of attack between α=3.5° and 5° (FIG. 14A and FIG. 14C). In this situation, lift and power factor would be very sensitive to the effects of free-stream turbulence and small variations in the angle of attack. Laminar reattachment at low angles of attack could not be avoided even though a cavity depth almost as deep as the airfoil thickness was used, with the airfoil thickness below the cavity kept constant at 1% (depicted in FIG. 13A). The distance required for laminar reattachment depends on Re_{θS} and h_{C}, which, however, are constrained by the cavity leading edge location and airfoil thickness.

A possible solution to the laminar reattachment problem at low angles of attack, is to move the cavity away from the leading edge so as to increase the Reynolds at separation from Re_{θS}≈10. Positioning the cavity at x_{C}=5% results in Re_{θS}≈20 and a cavity length of 35% (FIG. 13A), transition occurs at 62% (FIG. 12B). Although the flow remains separated, turbulent transition initiates the reattachment process which is almost complete at the trailing edge (FIG. 12B). The new cavity design at Re_{C}=10,000 successfully keeps the shear layer at a large distance from the wall over a broad range of angles of attack, α=1°-8° (FIG. 12B).

Despite the fact that the airfoil with x_{C}=5% cavity does not achieve as high maximum lift and power factors as the airfoil with the cavity positioned closer to the leading edge, both lift and power factor are considerably improved for angles of attack below 5° (FIG. 14A and FIG. 14C).

The lift of the AG14HC airfoil with the cavity located at x_{C}=5% is more than doubled as compared to the lift of the baseline AG14 airfoil (FIG. 14A, FIG. 14B). The presence of the x_{C}=5% cavity improves the airfoil power factor by more than 100% compared to the power factor of the AG14 airfoil (FIG. 14C) and a similar gain is achieved over the performance of the AG14HC airfoil without a cavity.

Wind Tunnel Testing at Re_{c}=10,000-30,000

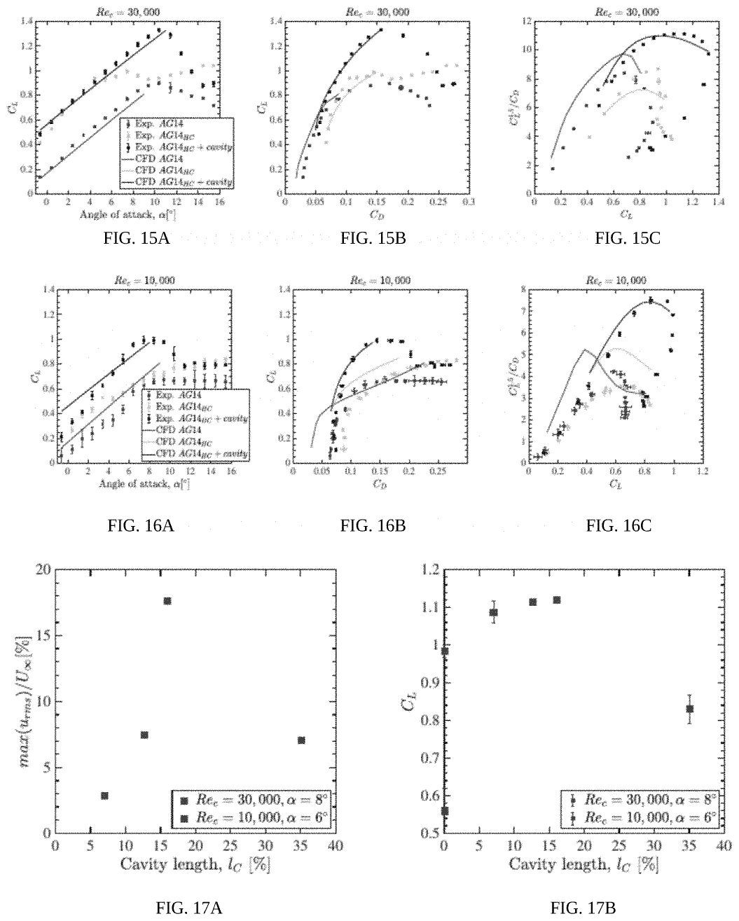

Wind tunnel measurements of lift and drag at Re_{c}=30,000 confirmed that, although increasing airfoil camber generates higher lift levels (FIG. 15A, FIG. 15B), the maximum power factor remains mostly unchanged (FIG. 15C). In contrast, introducing the cavity increases the maximum lift by as much as 50% (FIG. 15A, FIG. 15B) and the wing power factor is improved by more than 30% (FIG. 15C).

Power factor improvements are also achieved at α<6° because, although the introduction of the cavity does not increases airfoil lift (FIG. 15A), it reduces the drag. The XFOIL-AVL model predictions are in excellent agreement with the C L measurements, and the power factor predictions are also acceptably accurate. This gives confidence in our use of XFOIL as a low-Re simulation tool for transitional separated flows.

At Re_{c}=10,000, an increase in camber only slightly improves the lift but has little effect on the power factor (FIG. 16A, FIG. 16B and FIG. 16C). However, introducing the cavity improves lift by as much as 50% and the maximum wing power factor by 80% (FIG. 16A and FIG. 16C). Good agreement between the simulation and experimental power factors is observed only when the lift levels predicted from AVL are in good agreement with the wing lift (AG_{HC} with cavity at α=4-8°). The poor agreement for α<4°, and for the other two wings (AG_{HC} and AG₁₄) is due to the model's inability to correctly predict the wing lift levels. For a given angle of attack, the vortex lattice method in AVL determines the wing lift based on the airfoil camber line and thin airfoil theory. We believe that large scale flow separation changes the effective airfoil camber line and reduces the airfoil and wing lift. This effect could not be taken into account with the present AVL model.

The lift and power factor improvements at Re_{C}=30,000 and 10,000 are due to the ability of the cavity to generate turbulent flow over the airfoil suction side and this keeps the flow attached further downstream. Evidence for the presence of turbulent flow can be seen from the velocity fluctuations measured using a hot-wire anemometer positioned inside the boundary layer at the cavity trailing edge (FIG. 17A). Fluctuation levels above ≈10% indicate that a turbulent boundary layer is achieved for the 16% long cavity (Re_{c}=30,000) when α=8° (angle of attack for wing maximum power factor). Reducing the cavity length results in smaller velocity fluctuations at its trailing edge, indicative of laminar flow persisting at this location, and lowers lift generation (FIG. 17B) likely because of increased flow separation in the airfoil trailing edge area.

At Re_{c}=10,000 and α=6°, the boundary layer is likely still undergoing transition to turbulence at the cavity trailing edge, with fluctuation levels of 7% (FIG. 17A) in agreement with the simulated boundary layer (FIG. 12B).

Cavities at Re_{c}<10,000

Although moderate airfoil camber and turbulent flow can improve airfoil performance, can a cavity generate turbulent flow when the Reynolds number is further reduced below 10,000? The design case at Re_{c}=10,000 showed that when the cavity is positioned in the immediate proximity of the leading edge (e.g., x C=1%), the shear layer experiences laminar reattachment from laminar reattachment at small angles of attack. Reattachment stabilizes the shear layer by reducing its shape factor, prevents transition to turbulence and reduces lift and power factor.

Unfortunately, as one lowers Re_{c} even further, the cavity optimal placement moves closer and closer toward the leading edge for two reasons. First, the cavity depth increases with lower Re_{c} (Eq. 5). Therefore, the requirement to maintain airfoil solidity requires a cavity placement closer to the leading edge, as seen earlier in the discussion of the cavity design at Re_{c}=30,000 and Re_{c}=10,000. Second, the transition distance, already lengthened due to a lower Re_{c}, extends even more with separation occurring far from the leading edge, soon reaching values comparable to the airfoil chord. For both these reasons, to improve the power factor, the cavity needs to be close to the leading edge.

The lower Re_{c} and x_{c} result in a smaller Reynolds at separation, Re_{θS}, and thus the separated shear layer is more susceptible to laminar reattachment. This could be avoided, in principle, by increasing the cavity depth but how does the required depth scale with the chord Reynolds number, Re_{C}?

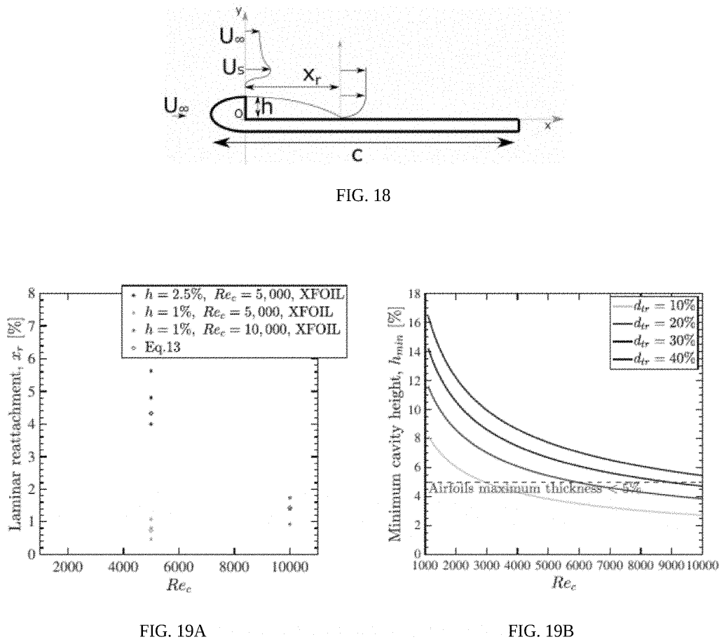

A necessary (although not sufficient) condition for transition is that the transition distance, dₜᵣ (normalized by the airfoil chord and depicted for a cavity in FIG. 2), is shorter than the distance the laminar flow takes to reattach over the cavity surface, xᵣ (normalized by the airfoil chord, FIG. 18):

xᵣ>dₜᵣ (6)

We employ a model to predict the laminar reattachment distance, xᵣ, based on experiments in channel flows over a backward-facing step of dimensional height, h. In those experiments, a correlation for the dimensional laminar reattachment distance, xᵣ was derived:

$$\text{?} \\ \text{?} \text{indicates text missing or illegible when filed} \qquad ( 7 )$$

where δ₊* is the displacement thickness at separation and Re_{δ+*} is the corresponding Reynolds number. It is assumed that the shape factor at separation is equal to that of a zero-pressure gradient laminar boundary layer over a flat plate, H=2.59 and δ₊*=2.59θ_{S}. Furthermore, if the speed at separation is assumed equal to the free stream velocity, it is possible to write:

$$\text{?} = \text{?} h . \\ \text{?} \text{indicates text missing or illegible when filed} \qquad ( 8 )$$

with h=h/c. Replacing h/δ₊* with /θ_{S} in Eq. 7, introducing Eq. 8 and normalizing with the airfoil chord:

$${x}_{r} = 0.1325 Re \text{?} h ( \text{?} h + 0.8 ) \\ \text{?} \text{indicates text missing or illegible when filed} \qquad ( 9 )$$

The equation above can be further simplified, expressing the Reynolds at separation, Re_{θS}, as a function of Re_{c}. The airfoil leading edge area is approximated by a circle with radius, r_{LE}, and using the following to predict the boundary layer characteristics for a stagnation point:

$$\frac{{θ}_{S}}{{r}_{LE}} \sqrt{\frac{2 {U}_{∞}}{{vr}_{LE}}} = 0.2711 , \qquad ( 10 )$$

which can be rewritten as:

$$\text{?} = \sqrt{0.2711 \text{?} \sqrt{\frac{{k}_{R}}{2}}} , \\ \text{?} \text{indicates text missing or illegible when filed} \qquad ( 11 )$$

where k_{R} represents the leading edge radius-to-airfoil chord fraction. A reasonable assumption for k_{R} is a dependency on airfoil thickness, t, similarly to the NACA airfoil family where k_{R}=1.1 t 2. Assuming, for simplicity, that t=5% leads to the following result:

Re_{θ}_{_{S}}≈0.1\sqrt{Re_{c}}. (12)

and substituting Eq. 12 into Eq. 9, we obtain:

xᵣ=0.001325\sqrt{Re_{c}}h(10\sqrt{Re_{c}}h+0.8). (13)

To validate Eq. 13, the laminar reattachment distance was also obtained using XFOIL simulations of the flow over an AG14HC airfoil modified with a cavity placed at x_{C}=1% and 1C=30%. For each set of Re_{C} and cavity depths, h, simulations were performed at α=4°, 6°, and 8°. The use of Eq. 13 is validated, at least for these purposes, by the reasonable agreement between its predictions and the XFOIL computations in the range Re_{c}=5,000-10,000 (FIG. 19A).

The minimum cavity height, hmin, necessary (but not sufficient) to avoid laminar reattachment from hindering transition in the range Re_{C}=1,000-10,000, is determined by imposing the condition xᵣ>dₜᵣ. With xᵣ expressed from Eq. 13, for each combination of Re_{C} and d_{TR}, hₘᵢₙ corresponds to the positive root of:

0.01325Re_{c}h²+0.00106\sqrt{Re_{c}}h−dₜᵣ=0, (14)

with results shown in FIG. 19B.

Given that low Reynolds airfoils typically have a maximum thickness well below, avoidance of laminar reattachment requires cavities too deep to ensure airfoil solidity, unless the transition distance is shorter than 10-20% of the chord. This criteria cannot be possibly met in a low free stream turbulence environment, as the transition distance, expected to increase at lower Re_{C}, is already ≈30% of the airfoil chord at Re_{c}=10,000.

However, the transition distance could be shortened using flow control devices to artificially increase the amplitude of the velocity disturbances at separation, v_{xS} (Eq. 3). Flow disturbances as small as a few percent of the velocity at separation could be sufficient to substantially reduce the transition distance.

The cavity geometry studied here (i.e., with a downstream inner surface gradually joining the airfoil surface, makes it susceptible to laminar reattachment. A possible direction for further study is the role of the cavity trailing edge to keep the shear layer separated from the airfoil surface. A downstream inner surface of the cavity joining the airfoil surface at or close to 90 degrees, akin to a forward facing step, may help delay flow reattachment. Such a geometry, however, may also cause large boundary layer disruptions and additional studies are needed to assess the overall benefit. Moreover, the leading edge geometry affects the cavity length and depth, as the momentum thickness and the boundary layer velocity at separation depend on the boundary layer development upstream.

In summary, the present invention is a design to improve airfoil power factor in the Reynolds number range 10,000-30,000. The power factor improvement was achieved through a combination of increased airfoil camber and the use of a cavity to generate turbulent flow on the airfoil suction side. The cavity dictates the location of flow separation and ensures an adequate distance between the separated shear layer and the solid surface. This maximizes the growth of disturbances inside the unstable shear layer, and accelerates the flow transition to turbulence. A method to determine the cavity position, depth and length was derived and applied to modify an existing AG14 airfoil for operations at Re_{C}=30,000 and Re_{C}=10,000. Simulations showed that, compared to the AG14 airfoil, the increased camber and the introduction of the surface cavity improved the airfoil aerodynamic power factor by 100% at both Re_{c}=30,000 and Re_{c}=10,000.

Wings based on the cavity airfoils showed power factor improvements of 30% and 80% in wind tunnel testing at Reynolds 30,000 and 10,000. The computational predictions from XFOIL and AVL were in good agreement with the wing force measurements at Reynolds 30,000 and 10,000. Hot wire measurements confirmed that the cavity triggers a turbulent boundary layer. Some aspects of the cavity design, such as the effects of the cavity trailing edge geometry, remain open. To improve on the present work, more flow field information, such as velocity fields and pressure distributions, especially around and downstream of the cavity trailing edge, would provide valuable information.

Laminar reattachment of the separated shear layer over the cavity surface reduces cavity effectiveness at Re_{c}<10,000. A scaling analysis of the laminar reattachment process revealed that cavity depths compatible with airfoil thickness require faster transition from levels obtainable in low free stream turbulence environments.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. A free-streamline airfoil comprising:
a lower surface which is flat or contoured; and
an upper surface that is curved or made of discrete flat elements approximating a curved surface, the upper surface presenting a cavity, a cavity width in an airfoil chordwise direction shorter than the airfoil chord, a position and depth of the cavity triggering a turbulent flow over the airfoil's suction side while preserving the airfoil physical integrity.

2. The free-streamline airfoil of claim 1 wherein the cavity has a leading edge and a trailing edge.

3. The free-streamline airfoil of claim 2 wherein the cavity leading edge can be placed at the airfoil leading edge.

4. The free-streamline airfoil of claim 2 wherein the cavity leading edge can be placed at a distance downstream from the airfoil leading edge.

5. The free-streamline airfoil of claim 2 wherein a local cavity depth is shallower than a local airfoil thickness.

6. The free-streamline airfoil of claim 5 wherein a boundary layer separates from the airfoil surface at the cavity leading edge and the separated boundary layer has a shape factor increasing above five.

7. The free-streamline airfoil of claim 6 wherein the boundary layer is excited at separation with a flow control device located in the cavity leading edge area.

8. The free-streamline airfoil of claim 6 wherein the separated boundary layer remains distant from the airfoil surface due the cavity depth when the separated boundary layer shape factor remains at least five or higher.

9. The free-streamline airfoil of claim 8 wherein a transition of the separated boundary layer from laminar to turbulent flow occurs before the cavity trailing edge, and
wherein transition of the separated boundary layer from laminar to turbulent flow occurs after the cavity trailing edge.

10. The free-streamline airfoil of claim 9 wherein the turbulent separated boundary layer reattaches on the cavity surface before or at the cavity trailing edge and becomes a turbulent boundary layer attached over the airfoil surface with a turbulent boundary layer shape factor decreasing below five.

11. The free-streamline airfoil of claim 9 wherein the turbulent separated flow reattaches on the airfoil surface after the cavity trailing edge and becomes a turbulent boundary layer attached over the airfoil surface with a turbulent boundary layer shape factor decreasing below five.
